(19) United States
(12) Patent Application Publication
(10) Pub. No.: US 2026/0239055 A1
(43) Pub. Date: Aug. 13, 2026

(54) POLARIZATION INTERFERENCE MEASUREMENT AND REPORTING USING POLARIZED REFERENCE SIGNALS

(71) Applicant: InterDigital Patent Holdings, Inc., Wilmington, DE (US)

(72) Inventors: Virgil Comsa, Montreal (CA); Afshin Haghighat, Ile-Bizard (CA); Loic Canonne-Velasquez, Dorval (CA); Jonghyun Park, Syosset, NY (US)

(73) Assignee: InterDigital Patent Holdings, Inc., Wilmington, DE (US)

(21) Appl. No.: 19/470,934

(22) PCT Filed: Apr. 4, 2024
(86) PCT No.: PCT/US2024/022926

§ 371 Date: Sep. 30, 2025

Related U.S. Application Data
(60) Provisional application No. 63/457,038, filed on Apr. 4, 2023.

(51) Int. Cl. H04W 24/08; H04B 7/06

(52) U.S. Cl. CPC H04W 24/08; H04B 7/0626

(57) ABSTRACT

Systems, methods, and instrumentalities are configured to polarization interference measurement and reporting using polarized reference signals. A Wireless Transmit/Receive Unit (WTRU) may receive configuration information for Channel State Information Reference Signal (CSI-RS) measurements, including two polarization indices related to different polarization types. Upon receiving a trigger, for example, through downlink control information (DCI), the WTRU may perform and report CSI-RS measurements based on the polarization types. The WTRU may determine the polarization-based CSI-RS measurement using the configuration and polarization type indicated in the reporting information, and send such data to a network. The measurements may be based on the polarization indices in the reporting information.

### CROSS-REFERENCE TO RELATED APPLICATIONS

This application claims the benefit of U.S. Provisional Application No. 63/457,038, filed Apr. 4, 2023, the contents of which is incorporated by reference herein.

### BACKGROUND

Mobile communications using wireless communication continue to evolve. A fifth generation of mobile communication radio access technology (RAT) may be referred to as 5G new radio (NR). A previous (legacy) generation of mobile communication RAT may be, for example, fourth generation (4G) long term evolution (LTE).

### SUMMARY

Systems, methods, and instrumentalities are configured for polarization interference measurement and reporting using polarized reference signals. A wireless transmit/receive unit (WTRU) may receive channel state information reference signal (CSI-RS) measurement configuration information. The CSI-RS measurement configuration information may indicate a first polarization index and a second polarization index. The first polarization index may be associated with a first polarization type, and the second polarization index may be associated with a second polarization type. The WTRU may receive a trigger to perform polarization-based CSI-RS measurement reporting. The trigger may indicate reporting information. The WTRU may determine a polarization-based CSI-RS measurement based on the received CSI-RS measurement configuration information and based on the first polarization type or the second polarization type. The WTRU may send an indication to a network entity. The indication may indicate at least the polarization-based CSI-RS measurement. The polarization-based CSI-RS measurement may be determined based on the first polarization type or the second polarization type based on the reporting information. The trigger may be received in downlink control information (DCI). The reporting information may indicate the first polarization index or the second polarization index. The polarization-based CSI-RS measurement may be based on the first polarization index based on the reporting information indicating the first polarization index. The polarization-based CSI-RS measurement may be based on the second polarization index based on the reporting information indicating the second polarization index.

The polarization-based CSI-RS measurement may include one or more of a first polarization-based measurement based on the first polarization type or a second polarization-based measurement based on the second polarization type. The indication may indicate one or more of: a polarization type associated with one or more of the first polarization-based measurement or the second polarization-based measurement or an indication of a selected polarization type. The selected polarization type may include the first polarization type or the second polarization type. The polarization-based CSI-RS measurement may be based on the first polarization type or the second polarization type based on an RS source polarization.

Systems, methods, and instrumentalities are configured for polarization interference measurement and reporting using a polarized CSI-RS. A wireless transmit/receive unit (WTRU) may comprise a processor that is configured to receive a control state information reference signal (CSI-RS) measurement configuration, which may indicate at least one or more polarization information. Upon receiving a trigger for performing a polarization-based CSI-RS measurement reporting, the WTRU may determine the polarization-based CSI-RS measurement using the received CSI-RS measurement configuration and a polarization type based on the reporting information. The WTRU may send the polarization-based CSI-RS measurement.

In this WTRU, the polarization information may include multiple polarization indexes, with each index configured with a reference signal (RS) source that is uni-polarized. Each of these polarization indexes may be associated with a first and a second polarization type, which are determined based on the polarization of the RS source. The first polarization type may be horizontal polarization, while the second polarization type may be vertical polarization.

When two of the multiple polarization indexes are identified, the associated polarization types for each index may be different. For example, a first index may be associated with the first polarization type, while a second index may be associated with the second polarization type. The trigger and/or the CSI-RS measurement configuration may include reporting information, such as a reporting mode or sub-mode, which is used to determine whether to use the first or the second polarization type for CSI-RS reception and/or measurement.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment; and

FIG. 2 illustrates Multi RX reception with two panels (or sub-arrays) with two different DL polarization.

### DETAILED DESCRIPTION

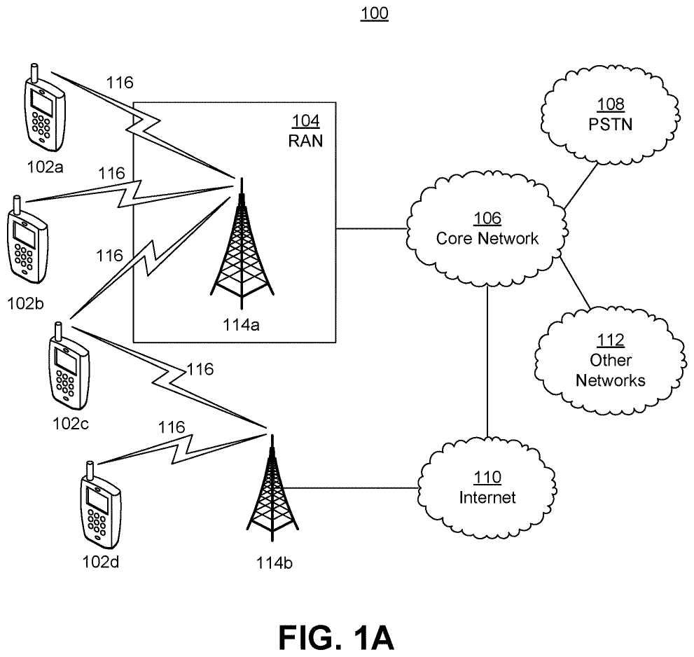

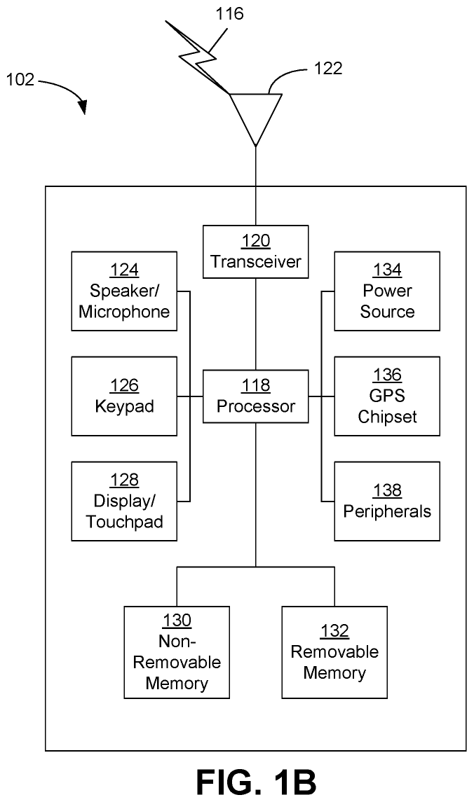

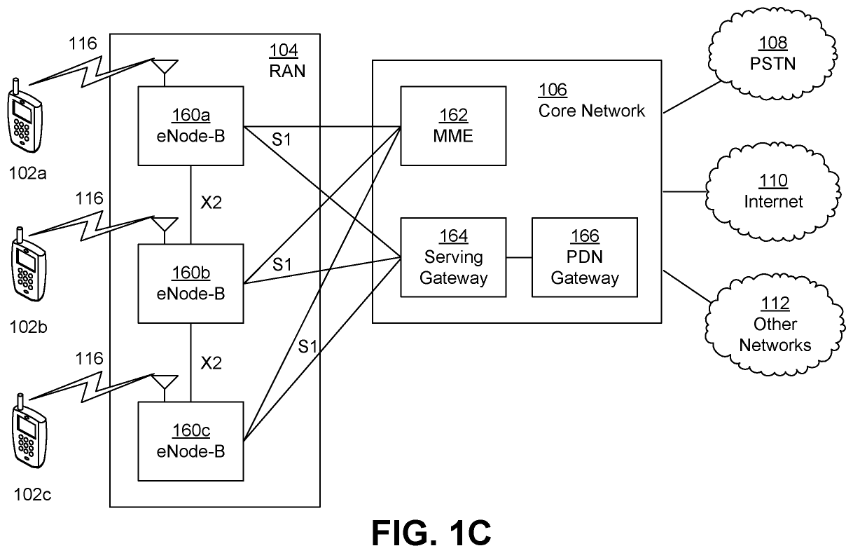

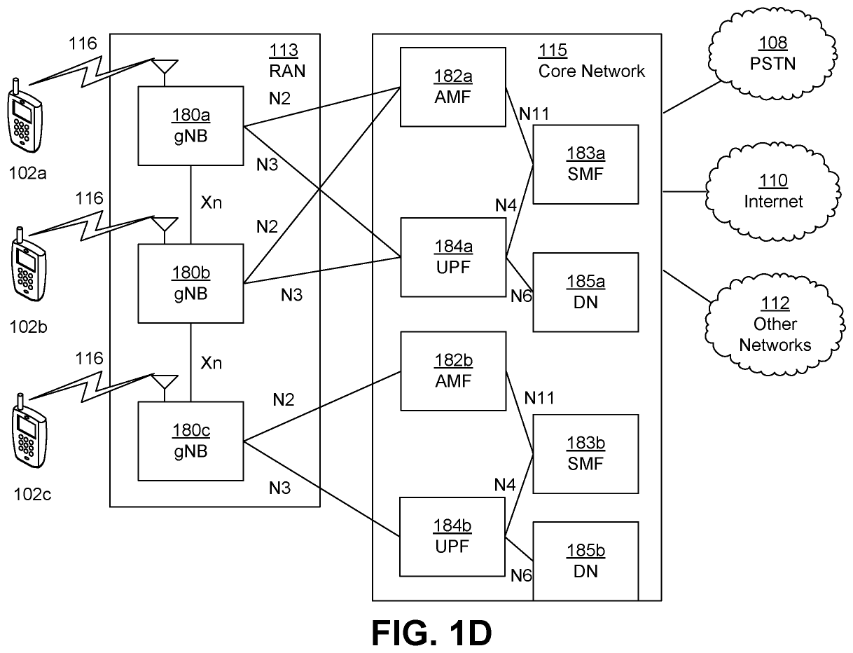

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., a eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., including varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Features described herein may be associated with a multi-panel WTRU. An MPUE or a MPWTRU may be a WTRU that is equipped with a multiple panels antenna and has the capability of receiving/transmitting multiple beams with different angles of arrival (AoA). Panels may be a structural part of a WTRU antenna system that has one or more of the following properties. It may be a unit of an antenna group that controls a beam. Within a panel, a beam may be selected and used for DL reception. Across panels (e.g., difference panels), multiple beams may be selected (e.g., one per panel) and may be used for DL reception. A physical panel with dual polarization may be seen as two panels (e.g., one per polarization. A beam may mean a spatial filter associated with reception (e.g., in a DL context). A beam may be associated with a TCI state describing a spatial filter associated with the reception of a beam.

As described herein, the polarization for a panel may be related to a cross-polarization capability of the antenna elements in the antenna system structure that allow for quasi-orthogonality of transmission/reception.

Features described herein may be associated with a polarization component (e.g., type-1 and type-2). A polarization component may represent the transmitted signal on one of the available polarizations of the antenna port antenna group or panel. In examples, a cross-polarized antenna may have a horizontal (Hz) and a vertical (Vt) component where the Hz and Vt components (e.g., type-1 and type-2, respectively) make use of the assigned Hz antenna elements and Vt elements, respectively.

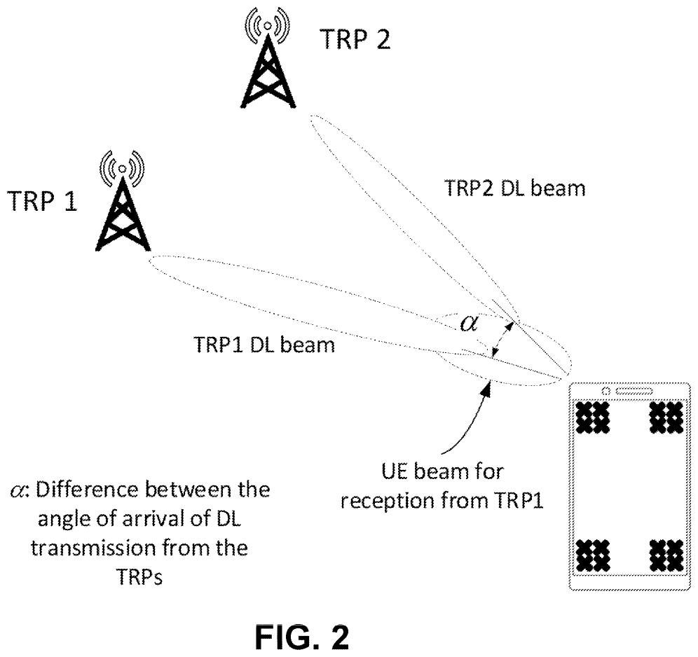

As described herein, the angle of arrival (AoA) a may be a relative angle between two received beams, as shown in FIG. 2. As described herein, the angle of departure (AoD) a may be a relative angle between two transmitted beams as shown in FIG. 2.

A WTRU may support multi-TRP reception in either sDCI or mDCI modes. In the mDCI mode, there may be simultaneous receptions from two non-collocated TRPs that are in inter-cell or intra-cell configurations. The configurations may (e.g., completely) overlap in frequency domain, using the same channel and channel bandwidth. Multi-RX may be referred to as the reception capability of a WTRU in a downlink multi-TRP configuration. Multi-RX WTRU testing methodologies may reveal that a muti-panel UE or a multi panel WTRU (MPWTRU) experiences inter-TRP interference. The terms MPUE and MPWTRU may be used interchangeably herein.

FIG. 2 illustrates Multi RX reception with two panels (or sub-arrays) with two different DL polarization. As shown in FIG. 2, the inter-TRP interference may be due to the fact that there is spillage of signal from a second TRP to a first TRP when a WTRU receiving beam is intended for reception from the first TRP. This may be detrimental to the WTRU's performance, for example, as the difference between the angle of arrivals from the two TRPs decreases. To mitigate inter-TRP interference, polarizations (e.g., difference polarizations) may be considered at a TRP. Techniques may detect, measure, and/or employ schemes to reduce inter-TRP interference at the WTRU side.

The current WTRU CSI measurements and network CSI-RS configurations may not be adequate. For example, the current WTRU CSI measurements may not consider polarization dimension at the WTRU side. A dimension for the CSI-RS transmission and measurement (e.g., polarization) may be provided to mitigate the MPUE inter-TRP interference.

The UL transmissions may be associated with a polarization operation based on multi-TRP being configured and UL overlapping transmissions in time and/or frequency occurring.

As MIMO capable systems support polarized antennas (e.g., cross-polarized), to enable/improve a Multi RX reception for MPUE, mitigation of the inter-polarization interference between receptions, polarizations at the transmission side (e.g., at a TRP) may be used. The WTRU may measure the inter-polarization interference and report it back to the network. To address the inter-polarization interference, the polarization of the RS pilots for the evaluation may be considered as a configuration, measurement dimension, and reporting.

Techniques for measuring the interference at the WTRU side may be limited to measurements on zero power (ZP) CSI resources that are known as CSI-IM resources. Configuration of ZP CSI-IM resources may provide an opportunity to measure the background system-wide interference. This technique (or any other RS related measurements) may not allow for inter-polarization interference measurements that would consider polarization dimension of the transmission/reception. The gNB may have cross-polarized elements in its antennas.

In a multi-TRP deployment, inter-polarization interference may be a performance-limiting factor. The multi-RX reception may be greatly improved by cross-polarization reception per panel for an MPUE. In some cases, support may not be provided for polarization-based CSI configuration, measurements, and reporting.

For the uplink MIMO transmission in a multi-TRP scenario, the polarization-based operation may be supported (e.g., for the simultaneously transmissions for the multi-panel WTRUs (STxMP). In an mDCI case, where the UL grants may come independently overlapping or non-overlapping RB allocations may occur. When the RB allocations overlap due to complexity of MPR (Maximum Power Reduction) application rules, and the WTRU implementation is challenged for antenna panels, the polarization-based operation may reduce the complexity and a number of parameters to account for to avoid self-interference (e.g., when two timing advance (TA) situations are to be accounted for UL power imbalance, transmission polarization selection).

For operations affected by the polarization-based uplink simultaneous transmissions in a multi-TRP scenario, the PHR (Power Headroom Report) may take into consideration power allocation that may be polarization based and related to a WTRU's power per/panel/polarization capabilities. Systems and methods associated with the polarization-based operation may be provided.

In examples addressing inter-polarization interference, an MPUE may be referred to as the target device, and a (e.g., the same) technique and discussion may be applied to a single panel WTRU with simultaneous multiple receive beam capability. A two TRP system may be used, and a technique (e.g., the same technique) may be applied for a system with more than two TRPs.

Features described herein may be associated with polarization-based operation for cross-polarization interference mitigation, including CSI-RS measurements, UL operations and PHR operation.

Features described herein may be associated with a polarization interference measurement and reporting using polarized a CSI-RS.

A WTRU may be configured to perform and/or the WTRU may perform one or more of the following. A WTRU may receive a channel state information reference signal (CSI-RS) measurement configuration (e.g., CSI-RS measurement configuration information) (e.g., associated with a first transmission reference point (TRP), e.g., TRP1) that includes (e.g., indicates) polarization information (e.g., one or more polarization indexes, such as a first polarization index or a second polarization index). The CSI-RS measurement configuration may identify one or more NZP-CSI-RS resources, one or more ZP-CSI-RS resources, and/or one or two polarization indexes (e.g., for use with the NZP-CSI-RS resource(s). The NZP-CSI-RS resource(s) may be associated with the first TRP, e.g., TRP1. The ZP-CSI-RS resource(s) may be associated with a second TRP, e.g., TRP2.

A polarization index may be configured or associated with a respective RS source (e.g., an SSB or CSI-RS) that is uni-polarized. A polarization index (e.g., one or more of a first polarization type or a second polarization type) may be associated with a polarization type, for example, a type-1 polarization or type-2 polarization (e.g., one or more of a first polarization or a second polarization type), where, for example, type-1 polarization may be a first orientation (e.g., horizontal (H)) and type-2 polarization may be a second orientation (e.g., vertical (V)) (or vice versa). The polarization type associated with a polarization index may be determined from the polarization of the configured or associated RS source. When two polarization indexes are identified, the associated polarization types may be different (e.g., one polarization index may be a type-1 polarization index, and the other polarization index may be type-2 polarization index). The measurement configuration may indicate a measurement timing type such as aperiodic, semi-persistent, or periodic. The NZP-CSI-RS resource(s) may be associated with a beam (e.g., via a configured indicated or activated TCI state or QCL properties). The polarization information may correspond to or may be associated with a type of QCL information that is be configured for an RS, such as QCL type E.

The WTRU may receive a trigger to perform CSI-RS measurement reporting. In examples, the trigger may be received in a DCI (e.g., aperiodic reporting). The trigger may be time or timer based (e.g., periodic reporting). The trigger may be time or timer based conditioned on activation (e.g., semi-persistent reporting). The trigger and/or the CSI-RS measurement configuration (e.g., the CSI-RS measurement configuration information) may include reporting information (e.g., a reporting mode or sub-mode), where the reporting information may be used to determine a polarization type to use for CSI-RS reception and/or measurement. The WTRU may determine a polarization-based CSI-RS measurement (e.g., the WTRU may perform a polarization-based CSI-RS measurement) based on the received CSI-RS measurement configuration (e.g., the received CSI-RS measurement configuration information) and based on a polarization type (e.g., a first polarization type or a second polarization type). The polarization type may be determined based on the reporting information. The WTRU may report (e.g., send, in an indication to a network entity) at least the polarization-based CSI-RS measurement.

In some examples, the WTRU may be triggered (e.g., using layer 1 (L1) signaling) (e.g., by a received downlink control information (DCI)) to perform CSI measurement reporting. A trigger received via a DCI, for example, may include reporting information that indicates a polarization index (e.g., the first polarization index or the second polarization index). The WTRU may determine the polarization type to use for the measurement based on the polarization type (e.g., the first polarization type or the second polarization type) of the RS source associated with the polarization index. The WTRU may perform, using the determined polarization type, a polarization-based measurement based on at least one CSI-RS, where the at least one CSI-RS is received in the configured NZP-CSI-RS resource(s) (e.g., the WTRU may measure a CSI-RS in one or more instances of an NZP-CSI-RS resource). The WTRU may use the ZP-CSI-RS resource(s) for measuring interference. The WTRU may report (e.g., to a TRP) the polarization-based measurement.

In some examples, the WTRU may be triggered (e.g., by a received DCI) to perform CSI reporting using type-1 polarization and type-2 polarization (e.g., a first polarization type and second polarization type). The WTRU may determine a first polarization-based measurement using polarization type-1 and a second polarization-based measurement using polarization type-2, and the measurement may be determined based on a respective at least one CSI-RS received using the configured NZP-CSI-RS resource(s). For the measurements, the WTRU may use the ZP-CSI-RS resource(s) for measuring interference.

The WTRU may report one or more of the following: the first polarization-based CSI-RS measurement (e.g., using the first polarization type); the second polarization-based measurement (e.g., using the second polarization type); an indication that identifies the polarization type used for a reported measurement (e.g., the polarization type may be associated with one or more of the first polarization-based measurement or the second polarization-based measurement; the polarization-based measurement for a selected (e.g., best or preferred) polarization type from among the first and second polarization types; and/or an indication of which polarization type is the selected polarization type (e.g., the selected polarization type may be the first polarization type or the second polarization type).

The WTRU may be configured with a second CSI-RS measurement configuration that may be associated with TRP2. The WTRU may be triggered to perform polarization-based measurements for TRP1 and/or TRP2. The CSI-RS resources used for the TRP1 and TRP2 measurements may be TDMed (e.g., multiplexed in time).

Features described herein may be associated with UL polarization-based operation. A WTRU may do one or more of the following. A WTRU may declare (e.g., indicate) a power capability, for example, as power sharing or non-power sharing. The power capability may be associated with one or more antenna ports or antenna port groups.

The WTRU may receive a first UL grant and a second UL grant for a respective first and a second UL (e.g., PUSCH) transmission, and the RB allocations (e.g., indicated by the respective UL grants) may overlap in time and/or frequency. The first UL transmission may use a first polarization type (e.g., type-1), and the second UL transmission may use a second polarization type (e.g., type-2). The first UL grant and the second UL grant may be received in a DCI (e.g., a same DCI) or in separate DCIs. The first UL grant and the second UL grant may include information indicating the polarization type (e.g., type-1 or type-2) to use for the respective first and second UL transmissions. For example, an indicator in a grant or DCI (such as SRI or TCI) that may be associated with polarization information (e.g., QCL type E) may indicate (e.g., may be used to indicate) the polarization type for a UL transmission.

The WTRU may determine a first maximum configured power for the first polarization type (Pcmax1) (e.g., a maximum power associated with the first polarization type) and a second maximum configured power for second polarization type (Pcmax2) (e.g., a maximum power associated with the second polarization type). Type-1 polarization and type-2 polarization may be horizontal and vertical polarizations, respectively, or vice versa. Pcmax-Hz and Pcmax-Vt may be used to represent the maximum configured power Pcmax for the vertical and horizontal polarizations, respectively. The WTRU may determine that a sum of the maximum power associated with the first polarization type (Pcmax1) and the maximum power associated with the second polarization type (Pcmax2) exceeds a threshold. If Pcmax1+Pcmax2 (e.g., Pcmax-Hz+Pcmax-Vt) exceeds a threshold value (e.g., the WTRU power class or the WTRU power class for EIRP), the WTRU may scale (e.g., update) one or both of Pcmax1 and Pcmax2 (e.g., such that the sum of Pcmax1 and Pcmax2 does not exceed the threshold value).

The WTRU may compute the allocated power for the PUSCH transmissions, e.g., P1 and P2, and may adjust the transmission power(s) for each of the PUSCH transmissions, if needed, to not exceed Pcmax1 and Pcmax2, respectively. In some examples, P1 may be adjusted to not exceed a scaled Pcmax1 and P2 may be adjusted to not exceed a scaled Pcmax2. In some examples, if computed P1>Pcmax1, transmission P1 is Pcmax1; otherwise, transmission P1=computed P1. In some examples, if computed P2>Pcmax2, transmission P2 is Pcmax2; otherwise, transmission P2=computed P2.

The WTRU may transmit the first UL transmission using the computed or adjusted P1 power, where the first UL transmission uses the first polarization type. The WTRU may transmit the second UL transmission using the computed or adjusted P2 power, where the second UL transmission uses the second polarization type.

Pcmax scaling examples may include the following. In an example, if both UL (e.g., PUSCH) transmissions include UCI or both UL (e.g., PUSCH) transmissions do not include UCI, Pcmax1 and Pcmax2 may be scaled equally. In an example, if one of the first and second UL (e.g., PUSCH) transmissions includes UCI and the other does not (e.g., one of the first UL transmission or the second UL transmission lacks UCI and one of the first UL transmission or the second UL transmission includes UCI), a Pcmax may be scaled (e.g., the Pcmax (Pcmax1 or Pcmax2) corresponding to the UL transmission that does not include UCI may be scaled).

In an example, determining the maximum configured power per polarization type (e.g., and performing the subsequent related actions) may be conditioned on at least one of the following: the RB allocations of the first and second UL transmissions overlap in both time and frequency; the RB allocations of the first and second UL transmissions overlap in time; the same panel of the WTRU serves both the horizontal and vertical polarizations; and/or the WTRU indicates its power capability as power sharing (e.g., for the antenna ports or antenna port groups associated with one or both of the UL transmissions).

UL polarization-based operation may include PHR triggering and reporting. A WTRU may perform one or more of the following. A WTRU may declare (e.g., indicate) its power capability (e.g., the WTRU may send the power capability), for example, as power sharing or non-power sharing. The power capability may be associated with one or more antenna ports or antenna port groups.

If one or more of the following events occur or conditions are satisfied (e.g., the WTRU may determine that a condition is satisfied, and the condition may include one or more of the power capability of the WTRU changing or a serving panel of the WTRU changing, as described herein), the WTRU may trigger and/or send a power headroom report (PHR). The one or more events or conditions may include one or more of the following. The WTRU may be configured or reconfigured for multi-TRP (mTRP) operation (e.g., UL mTRP operation). The WTRU's power capability may change (e.g., the WTRU's power capability may change from power sharing to non-power sharing or from non-power sharing to power sharing). The WTRU's serving panel may change. The WTRU may determine that the difference between measured H-RSRP and measured V-RSRP exceeds a threshold (e.g., a received and/or configured threshold), for example, for at least an amount of time that may be configured. H-RSRP may be a polarization-based RSRP measurement of a first measurement RS using horizontal polarization. V-RSRP may be a polarization-based RSRP measurement of a second measurement RS using vertical polarization. A measurement RS may be an SSB, a CSI-RS, or a pathloss RS, and the first and second measurement RSes may be the same or different measurement RSes. The UL polarization of the WTRU is using for a TRP changes. The Pcmax for the active polarization type changes (e.g., may change) by more than a threshold (e.g., Pcmax for the active polarization type may be received and/or configured).

The PHR may include at least one of the following: a power capability of the WTRU (e.g., its current or active power capability) which may be sharing or non-sharing; a maximum power associated with a first polarization type (e.g., a first orientation polarization type associated with a horizontal polarization Pcmax (Pcmax-Hz); a maximum power associated with a second polarization type (e.g., a second orientation polarization type associated with a vertical polarization Pcmax (Pcmax-Vt)); and/or an indication of the active UL polarization (e.g., the active UL polarization may be horizontal or vertical polarization). An indication (e.g., the indication of the active UL polarization) in a PHR may be provided per TRP. A TRP indication (e.g., a per TRP indication) may be provided to identify the TRP associated with the UL polarization (e.g., an active UL polarization indication). The order of the entries of the active UL polarization indications in the PHR may determine or indicate the associated TRP.

An RS resource may be applicable for polarization-aware measurement. A WTRU may receive, e.g., from a gNB, configuration for a downlink (DL) RS (resource) that may be associated with (e.g., may indicate, may include) polarization information. For example, the DL RS resource may be one of following: a CSI-RS (resource); a tracking RS (e.g., a CSI-RS resource with an associated parameter of ‘TRS-info’ being enabled); a beam management CSI-RS (e.g., a CSI-RS resource with an associated parameter of ‘repetition’ being enabled, e.g., set to be ‘ON’ or ‘OFF’); an SSB (index); a pathloss (PL) RS, e.g., configured to be applicable for polarization-aware measurement; a demodulation RS (DMRS), e.g., particularly configured to be applicable for polarization-aware measurement; and/or a particularly configured type of DL-RS, e.g., applicable for polarization-aware measurement.

Examples may include polarization information. A WTRU may receive polarization information. In response to receiving the polarization information, the WTRU may identify (or determine) one of following. The WTRU may identify one or more polarization components, e.g., polarization component type-1 and/or type-2, etc. A polarization component may be represented by a polarization index, e.g., based on the polarization information includes one or more polarization indexes. The WTRU may identify polarization. Polarization component type-1 may be horizontal (H) and polarization component type-2 may be vertical (V) (e.g., or vice versa), etc. A polarization component (e.g., another polarization component) type may be defined (or configured to the WTRU), e.g., circular polarization type (e.g., right-hand circular polarization type-x, left-hand circular polarization type-y), cubic polarization type-z, etc. The WTRU may identify one or more components (other than polarization components) that are related to wireless communication between a transmitter (e.g., gNB or WTRU) and a receiver (e.g., WTRU or gNB), e.g., beamforming component type-j, spatial-domain component type-k, precoding component type-l, power control component type-m, antenna/panel component type-n, etc.

Polarization information may be indicated. The polarization information, e.g., being associated with (or included in) the DL RS (resource), may be provided (e.g., configured, indicated) based on at least one of following. The polarization information may be based on one or more explicit indicators, e.g., polarization indexes, to indicate which polarization type(s) are associated with the DL RS resource. For example, a polarization index may be associated with a polarization type, for example type-1 or type-2 polarization where, for example, type-1 may be horizontal (H) and type-2 may be vertical (V) (or vice versa). In an example, a WTRU may be configured with the DL RS resource (e.g., a CSI-RS resource) that is associated (e.g., explicitly associated) with a type-1 polarization. The WTRU may be configured to measure the DL RS resource, based on assuming its type-1 polarization. The WTRU may derive (or determine) a measurement quantity (e.g., RSRP, RSRQ, SINR, CQI, etc.) based on the type-1 polarization, and may report the measurement quantity along with a flag associated with the type-1 polarization. The flag may enable polarization-specific (or polarization-aware) measurement and reporting.

The polarization information may be based on one or more quasi co-location (QCL) type parameter(s), e.g., a QCL type E (representing ‘polarization’), or at least one of existing QCL types of QCL type A, B, C, D on which the gNB may configure (e.g., enable, add) an additional QCL property based on the ‘polarization’ property or component. For example, the WTRU may be configured (or indicated) with a parameter that may enable (e.g., add) a QCL property, e.g., ‘polarization’ property or component, on top of at least one of the following existing QCL type A, B, C, and/or D: QCL type A: {Doppler shift, Doppler spread, average delay, delay spread}; QCL type B: {Doppler shift, Doppler spread}; QCL type C: {Doppler shift, average delay}; and/or QCL type D: {Spatial Rx parameter}.

The WTRU may be configured (or indicated) with a (higher-layer) parameter (e.g., an RRC parameter) that may enable a QCL type, e.g., QCL type E, to be used for at least one RS resource or DL/UL channel, where the QCL type may represent: a QCL type E: {Polarization (and/or the like)}.

The WTRU may be configured with the DL RS resource (e.g., a CSI-RS resource) which may be associated with a QCL-source RS (e.g., a second CSI-RS resource or a second SSB index) with respect to QCL type E. The WTRU may be configured to measure the DL RS resource by using the same (or associated) polarization property or component that is used for receiving the associated QCL-source RS. The WTRU may derive (or determine) a measurement quantity (e.g., RSRP, RSRQ, SINR, CQI, etc.) based on the same (or associated) polarization property or component and may report the measurement quantity, e.g., along with the RS resource ID, which may enable polarization-specific (or polarization-aware) measurement and reporting, since the gNB may already know the QCL relationship between the RS resource and its QCL-source RS, with respect to QCL type E.

The WTRU may be configured with the DL RS resource (e.g., a CSI-RS resource). The DL RS resource may be a QCL-source RS with respect to QCL type E, e.g., via a TCI-state configuration, and may not be associated with a QCL-source RS (e.g., a second CSI-RS resource or a second SSB index) with respect to QCL type E. The WTRU may be configured to measure the DL RS resource by assuming one polarization property or component (e.g., type-1 or type-2). The WTRU may derive (or determine) a measurement quantity (e.g., RSRP, RSRQ, SINR, CQI, etc.) based on the assumed polarization property or component (e.g., type-1 or type-2), and may report the measurement quantity along with a flag indicating the assumed polarization property or component (e.g., type-1 or type-2), which may enable polarization-specific (or polarization-aware) measurement and reporting.

The polarization information may be based on one or more implicit rules to identify whether the DL RS resource is applicable for polarization-aware measurement. In examples, one or more antenna port (AP) group(s) of the DL RS resource may be used for (implicitly) determining the polarization information. The AP groups may include a first AP group (e.g., odd-numbered APs) of the DL RS resource may represent (e.g., be associated with) a first polarization components, e.g., type-1 polarization. The AP groups may include a second AP group (e.g., even-numbered APs) of the DL RS resource and may represent (e.g., be associated with) a second polarization components, e.g., type-2 polarization.

For example, a CSI-RS antenna port indexing rule may be associated with CSI reporting based on a (specific) codebook for precoder generations and may be used for (implicitly) determining the polarization information. A first group of APs (e.g., APs 0, 1, 4, 5) that belong to a same polarization based on the codebook may represent (e.g., be associated with) a first polarization component, e.g., type-1 polarization. A second group of APs (e.g., APs 2, 3, 6, 7) that belongs to another same polarization based on the codebook may represent (e.g., be associated with) a second polarization component, e.g., type-2 polarization.

The WTRU may be configured with the DL RS resource (e.g., a 8-port CSI-RS resource), which may be used for a CSI reporting. The WTRU may determine that the CSI reporting configuration is associated with a codebook for precoder generations, and may determine that APs 0, 1, 4, 5 belong to a same polarization and APs 2, 3, 6, 7 belong to another same polarization. In response to the determining, the WTRU may identify that a first group of APs (e.g., APs 0, 1, 4, 5) represents (e.g., is associated with) a first polarization component, e.g., type-1 polarization, and a second group of APs (e.g., APs 2, 3, 6, 7) represents (e.g., is associated with) a second polarization component, e.g., type-2 polarization.

The WTRU may derive (or determine) a first measurement quantity (e.g., RSRP, RSRQ, SINR, CQI, etc.) based on the type-1 polarization and over APs 0, 1, 4, 5 (e.g., not over the entire 8-ports of the DL RS resource). The WTRU may derive (or determine) a second measurement quantity (e.g., RSRP, RSRQ, SINR, CQI, etc.) based on the type-2 polarization and over APs 2, 3, 6, 7 (e.g., not over the entire 8-ports of the DL RS resource). The WTRU may report both the first measurement quantity (e.g., along with a first flag indicating the first group of APs) and the second measurement quantity (e.g., along with a second flag indicating the second group of APs). The WTRU may report a preferred (e.g., larger or smaller) measurement quantity among (e.g., between) the first measurement quantity and the second measurement quantity. In an example, the WTRU may determine that the first measurement quantity is larger than the second measurement quantity. In response to the determining, the WTRU may report the first measurement quantity (e.g., along with a first flag indicating the first group of APs), which may enable polarization-specific (or polarization-aware) measurement and reporting.

Features described herein may be associated with a QCL chain, e.g., with respect to QCL type E. A WTRU may be configured with a first RS resource (e.g., a first CSI-RS resource). The first RS resource may be of a QCL-source RS with respect to QCL type E, e.g., configured via a TCI-state configuration, and may not be associated with other QCL-source RS with respect to QCL type E. The WTRU may measure the first RS resource and determine its polarization component, e.g., either type-1 polarization or type-2 polarization, etc. In an example, the WTRU may determine that the first RS resource is associated with the type-1 polarization based on the measurement.

The WTRU may be configured with a second RS resource (e.g., a second CSI-RS resource). The second RS resource may be associated with a QCL-source RS that is the first RS resource with respect to QCL type E, e.g., where the second RS resource is associated with a TCI-state index that includes the first RS resource with respect to QCL type E. The WTRU may be configured to measure the second RS resource by using the same (or associated) polarization property or component (e.g., the type-1 polarization) that is used for receiving the associated QCL-source RS, which may be the first RS resource. The WTRU may derive (or determine) a measurement quantity (e.g., RSRP, RSRQ, SINR, CQI, etc.) based on the same (or associated) polarization property or component (e.g., the type-1 polarization) and may report the measurement quantity, e.g., with the second RS resource ID. The gNB may determine the QCL relationship between the second RS resource and its QCL-source RS (which is the first RS resource), with respect to QCL type E.

The WTRU may be scheduled to receive DL data (e.g., a PDSCH). The WTRU may receive a QCL relation with respect to QCL type E between the PDSCH and its QCL-source, which may be the second RS resource, for example. The WTRU may receive the PDSCH by using the same (or associated) polarization property or component (e.g., the type-1 polarization) that is used for receiving the associated QCL-source RS which is the second RS resource. The WTRU may determine that the type-1 polarization of the second RS resource comes from the top-QCL-source (e.g., the first RS resource), which may represent a QCL chain of the first RS resource, the second RS resource and the PDSCH, in orders. This may enable flexibility and efficiency in making alignment of a QCL type (e.g., QCL type E) across multiple RS resources and DL/UL channels, and may enable polarization-specific (or polarization-aware) measurement, reporting, data reception, and data transmission, etc.

In the following, the CSI-RS inter-polarization interference measurements are described for the aperiodic triggering mechanism, and they may be extended for semi-persistent or periodic mechanisms having the same measurements principles and triggered (e.g., activated/deactivated) differently by network. The measurement quantities may be reported as RSRP (RS power, RSRQ (RS quality), SINR (RS power over noise and interference), as ZP-CSI-RS may or may not be in place in the following listed solutions. The CSI-RS may be triggered as an aperiodic pattern for specific measurements.

The polarization interference may be measured and reported. The WTRU may be configured with an aperiodic CSI-RS that may be described by an RRC configuration, e.g., CSI-AperiodicTriggerStateList IE. A polarization-based measurement may include one or more of the following.

An example may include configuration of CSI-RS per polarization. A WTRU may receive a first and a second set of CSI-RS configuration corresponding to a first and a second transmission point, respectively. A set of CSI configuration may be configured with a CSI-RS where the configured CSI-RS may be associated with a different downlink beam, e.g., TRP, etc. The configured QCL information may be based on a QCL type that may include some information about the source polarization. The QCL may include at least an attribute to indicate the polarization associated with the sources reference signal. The polarization-related attribute in the QCL may be in the form of one or more of following.

In examples, the QCL may include an attribute to explicitly indicate a specific polarization, e.g., Pol1, Pol2, V, H, etc. In examples, the QCL may include an attribute to indicate its relative polarization with respect to the polarization of the source RS. The attribute may be co, cross, 45, etc., indicating whether the polarization of the configured CSI-RS has a same polarization as the source reference signal, (e.g., co-polarized), or whether the polarization of the configured CSI-RS has a different polarization. For an indicated QCL, a WTRU may employ a different spatial filter for CSI-RS reception and measurement. The QCL may be associated with an SRI for an uplink transmission.

In examples, the information related to the polarization of the configured CSI-RS may be indicated dynamically, for example, by the DCI triggering the aperiodic CSI measurement. The indication may be explicit or implicit. In examples, the DCI triggering the CSI measurement may include an information element, e.g., polarization index, that may be used to determine the polarization of the configured CSI-RS. In examples, the polarization information may be determined implicitly, for example, based on the slot number of the triggering DCI, time/frequency mapping of the CSI-RS resource, port index, etc.

In examples, a CSI configuration may be made up of one or more of CSI-RS types, e.g., ZP, NZP, etc., where a configuration may be associated with a different measurement mode. In an example for polarization-based CSI measurement, there may be modes (e.g., several modes) of measurements. A mode may require a different combination of CSI-RS. A configured NZP CSI-RS resource may be associated with a specific polarization. In examples, there may be two modes of measurements, e.g., in Mode 1, a pair of NZP and ZP CSI-RS resources may be configured, and in Mode 2, a single NZP CSI-RS resource may be configured.

Configured CSI-RS resources may have expected characteristics. A WTRU may receive a first and a second set of CSI-RS configurations corresponding to a first and a second transmission point, respectively. In Mode 1, a WTRU may assume that the configured NZP CSI-RS resources associated with a first transmission point coincides with the ZP CSI-RS resources associated with a second transmission point.

Features described herein may be associated with WTRU measurements. A polarization-based CSI measurement may be triggered for a WTRU. The WTRU may perform at least one or more of the measurements indicated in Table-1, for example, where a row describes a measurement hypothesis. In examples, a WTRU may perform a per TRP interference measurement on a polarization. As illustrated in Table 1, for measurements 1 and 2, a WTRU may be configured with a first and a second CSI-RS with types of ZP and NZP CSI-RS, respectively. A WTRU may assume that a first and a second polarization corresponding to measurements 1 and 2 are used for transmission of NZP CSI-RS resource by the 2nd TRP. For measurements 3 and 4, a WTRU may be configured with a first and a second CSI-RS with types of NZP and ZP CSI-RS, respectively. A WTRU may assume that a first and a second polarization corresponding to measurements 3 and 4 are used for transmission of NZP CSI-RS resources by the 1st TRP. A measurement, e.g., measurement 1, may be performed as follows. For separate measurements on a WTRU antenna polarization, for a given measurement hypothesis, a WTRU may perform a first measurement on a first WTRU antenna polarization, and a second measurement on a second WTRU antenna polarization. For a joint measurement the WTRU may perform measurement using both polarizations. For example, for a given measurement hypothesis, a WTRU may perform a single measurement by employing both antenna polarizations.

TABLE 1

| | | WTRU assumption | WTRU assumption |
|---|---|---|---|
| | WTRU received indication | for a 1st TRP | for a 2nd TRP |
| 1 | WTRU receives an indication for a measurement | No transmission | Transmission on a |
| | on a first polarization of a 2nd TRP | (ZP CSI-RS) | first polarization |
| | | | (NZP CSI-RS) |
| 2 | WTRU receives an indication for a measurement | | Transmission on a |
| | on a second polarization of a 2nd TRP | | second polarization |
| | | | (NZP CSI-RS) |
| 3 | WTRU receives an indication for a measurement | Transmission on a | No transmission |
| | on a first polarization of a 1st TRP | first polarization | (ZP CSI-RS) |
| | | (NZP CSI-RS) | |
| 4 | WTRU receives an indication for a measurement | Transmission on a | |
| | on a second polarization of a 1st TRP | second polarization | |
| | | (NZP CSI-RS) | |

Features described herein may be associated with WTRU reporting. In examples, a WTRU may perform one or more of the above measurements and report polarization-based measurements in different form. The measurement quantity and content may be configured and may be one or more of RSRP, RSRQ, SINR, rank, CQI, etc. For a configured measurement hypothesis, a WTRU may report one or more measurement quantities. Measurements 1 and 2 (and also 3 and 4) may be performed following the same trigger. A WTRU may report a single CSI report that may include measurements for both cases. Measurements 1 and 2 (and also 3 and 4) may (e.g., alternatively) be performed following separate indications, where a WTRU may assume that a single polarization is used during the measurement. A WTRU may report more than one CSI report, where a CSI report may include per hypothesis measurements.

In examples, a WTRU may also indicate explicitly or implicitly its preferred polarization according to the configured CSI-RS, e.g., transmission point. A WTRU may indicate that for reception from a first TRP, it prefers one polarization more than the other polarization. The indication may be carried using a pol_index, CRI, etc.

Measurement configurations (e.g., other measurement configurations) may be disclosed herein. As described herein, a set of measurement hypotheses and measurement steps and types may be described. The summary of the measurement hypothesis and measurement steps may be captured in Table-1. The configuration and measurement steps may be devised such that by completing a measurement step, inter-polarization between the two configured CSI-RS, e.g., TRP polarization, is measured.

Table-2 depicts an example that is based on a different measurement hypothesis set, steps and measurement type. By performing measurements 1 and 2, a WTRU may determine the better polarization for the 1st TRP, rather than determining the level of interference resulted from a transmission by the 2nd TRP. The measurement hypothesis for measurements 1 and 2 may include: NZP CSI-RS transmission by 1st TRP; and/or ZP CSI-RS transmission by 2nd TRP.

By performing measurements 3 and 4, a WTRU may determine the interference imposed on a polarization of the 1st TRP. The measurement hypothesis for measurements 3 and 4 may include: NZP CSI-RS transmission by 1st TRP; and/or PDSCH transmission by 2nd TRP.

Similar to the case illustrated in Table-1, measurements, e.g., measurement 1, may be performed in one or more of the following manners. For separate measurements on a WTRU antenna polarization, for a given measurement hypothesis, a WTRU may perform a first measurement on a first WTRU antenna polarization and a second measurement on a second WTRU antenna polarization. For a joint measurement using both polarization, for a given measurement hypothesis, a WTRU may perform a single measurement by employing both antenna polarizations.

TABLE 2

| | | WTRU assumption | WTRU assumption |
|---|---|---|---|
| | WTRU received indication | for a 1st TRP | for a 2nd TRP |
| 1 | WTRU receives an indication for a measurement | Transmission | No Transmission |
| | on a first polarization of a 1st TRP | NZP CSI-RS on a | (ZP CSI-RS) |
| | | second polarization | |
| 2 | WTRU receives an indication for a measurement | Transmission | No Transmission |
| | on a second polarization of a 1st TRP | NZP CSI-RS on a | (ZP CSI-RS) |
| | | first polarization | |
| 3 | WTRU receives an indication for a measurement | Transmission on a | Normal operation |
| | on a first polarization of a 1st TRP | second polarization | (no restrictions for |
| | | (NZP CSI-RS) | the PDSCH |
| | | | scheduling over the |
| | | | NZP-CSI-RS from |
| | | | the 1st TRP) |
| 4 | WTRU receives an indication for a measurement | Transmission on a | Normal operation |
| | on a second polarization of a 1st TRP | first polarization | (no restrictions for |
| | | (NZP CSI-RS) | the PDSCH |
| | | | scheduling over the |
| | | | NZP-CSI-RS from |
| | | | the 1st TRP) |

The WTRU may report its power sharing capability. On the UL, the WTRU may determine its transmission power based on the power control formula, for example, where the power is equally divided across the antenna ports. Various WTRU types of varying complexity, and with different antenna port coherencies may be supported. Such WTRUs may be equipped with different architectures with different connections between the PAs to the antenna panels, antenna ports, or antenna groups. In examples, a WTRU may report its power sharing capability as part of its capability report during initial access. The gNB may receive the capability report, and may configure the WTRU through RRC with a power sharing class. The WTRU may indicate in its capability report power sharing across one or more of the following: antenna port indices; antenna port group indices; antenna panel indices; antenna port coherency group indices; and/or polarization indices.

In an example, a WTRU may report that it supports a first antenna panel with a first polarization and a second antenna panel with a second polarization. The WTRU may report the number of antenna ports and polarization associated to a first antenna port group for panel 1, and the number of antenna ports and polarization associated to a second antenna port group for panel 2. A WTRU may support a number (e.g., different number) of antenna ports per antenna port group. A WTRU may indicate to support power sharing equally between (e.g., all) antenna ports regardless of antenna port group, or may support equal power sharing between antenna port groups, and equally within antenna ports in one antenna port group. If the WTRU does not report any power sharing capability, the network may determine that the WTRU supports equal power sharing.

A WTRU may transmit PUSCH with per polarization precoding. A WTRU may support transmission of more than one PUSCH at the same time, and the WTRU may receive one scheduling grant per PUSCH. A grant may independently assign time and frequency resources to the WTRU such that a WTRU may transmit on a fully overlapping, partially overlapping, or non-overlapping set of RBs. A grant may be sent from a different transmission point (TRP) on its respective CORESET, and a CORESET may be associated to a coresetPoolIndex (e.g., 0 for TRP0, 1 for TRP1). A WTRU may receive a single grant which includes resource allocation for both PUSCH transmissions to both TRPs.

In examples, a WTRU may be configured with an SRS resource set which explicitly indicates the polarization index such that (e.g., all) SRS resources in one set are associated to the same polarization. For example, based on the WTRU capability report, a WTRU may receive an RRC configuration which indicates that a first SRS resource set is configured with polarization index 1, and a second SRS resource set is configured with polarization index 2. The WTRU may receive a grant which includes a field with an SRI indicating an SRS resource from a SRS resource set, and the WTRU may determine to transmit the associated PUSCH with the polarization associated to the SRS resource set index.

A WTRU may be configured with an explicit polarization index per SRS resource. An SRS resource set may be configured with SRS resources associated to two different polarization indices. The WTRU may receive a grant which includes one or more fields with SRI(s) indicating SRS resource(s) from SRS resource set(s), and the WTRU may determine to transmit the associated PUSCHs with the polarization associated to the respective SRS resource index.

A WTRU may be configured with an association between a coresetPoolIndex and a polarization index, and with a polarization index per SRS resource or SRS resource set. The WTRU may determine the polarization index of the SRS resource or SRS resource set implicitly as a function of the coresetPoolIndex of the CORESET where the WTRU received the grant. In examples, a WTRU may be configured with coresetPoolIndex=1 for an SRS resource set with polarization 1, and a coresetPoolIndex=0 for an SRS resource set with polarization 0. The WTRU may receive a grant on a CORESET associated with coresetPoolIndex=1 and with an SRI field. The WTRU may determine that the SRI indicates an SRS resource from the SRS resource set 1 which is associated to the coresetPoolIndex=1.

A WTRU may be configured with a QCL assumption per SRS resource or SRS resource set (e.g., QCL TypeD or E) which indicates the polarization index associated to the SRS resource or SRS resource set. The WTRU may receive a grant which includes a field with a TCI, and the WTRU may determine to transmit the associated PUSCH with the polarization indicated by the TCI. The QCL assumption per SRS resource or SRS resource set may be updated by a MAC-CE with a co-phasing factor change that a WTRU may apply to the signal transmitted from the SRS antenna ports.

A WTRU may fall back to single transmission, for example, based on both grants scheduling on the same polarization. The WTRU may receive two UL grants. At least one RB resource may overlap in the two allocations. The WTRU may be scheduled to transmit with the same polarization index on both PUSCHs. If the WTRU is scheduled with the same polarization, the transmission signal quality may degrade due to cross-polarization interference. In examples, based on two UL grants overlapping with the same polarization index, a WTRU may fallback to transmit one of the PUSCHs. The WTRU may select the PUSCH based on a preconfigured rule, for example, based on one or more of the following: the WTRU may prioritize the polarization transmission based on an index (e.g., lowest coresetPoolIndex, SRS resource index, SRS resource set index, antenna port group index); the WTRU may prioritize the polarization transmission based on the TRP index; the WTRU may prioritize the polarization transmission with the highest CQI; and/or the WTRU may prioritize the polarization transmission with the highest measured signal quality (e.g., RSRP, SINR, SNR).

Pcmax may be determined per polarization. When the WTRU receives a UL grant from the gNB scheduler, the following parameters may be mentioned in a DCI: the RB allocation, the time domain symbols withing the slot, the Modulation and Coding Scheme (MCS) and the TCI related spatial filter. The precoding matrix index (PMI) may be important as well in relation with the UL antenna ports and MIMO operation. With these parameters, the WTRU may determine the maximum configured power (Pcmax) for a particular UL grant. The Pcmax equation or inequality may take in consideration (e.g., all) possible power reductions for emissions and power limits compliance. The Pcmax may be computed against the Power Class of the WTRU. Different form factors may have different power classes due to (e.g., typical) use cases required by the industry: Portable, Customer Premises Equipment (CPE), Wireless Access Point (WPA), Vehicular WTRU etc.

These form factors (e.g., all these form factors) may have different antenna configurations and capabilities. For UL case, the UL MIMO, multi-TRP may support simultaneous transmissions. The WTRUs supporting simultaneous transmissions feature may be multi-panel equipped (MPUEs). The support of STxMP may be related to the mDCI (multi DCI) support. The mDCI scheduling support may lead to the capability of transmitting simultaneous two code words into two (e.g., different) beams (e.g., two independent UL grants being treated and transmitted quasi-simultaneously). Since the two-timing advance (TA) loops are supported, the quasi-simultaneous transmissions may mean that the UL timing between the beams is not necessarily aligned, and the two UL slots are not fully aligned.

The Pcmax equation for FR2 (frequencies above 24 Ghz) may be not considering polarization-based operation in the UL (e.g., the power limit is considered against a power density computed as a sum over (e.g., all) antenna ports with allocation, while the power is distributed equally between the antenna ports).

The MPR and A-MPR (Additional Maximum Power Reduction-a coexistence supplementary reduction) may be considered against the sum over both polarizations if the WTRU antenna system supports cross-polarization. An example equation may appear as follows. The configured WTRU maximum output power PCMAX,f,c for carrier f of a serving cell c may be set such that the corresponding measured peak EIRP PUMAX,f,c is within the following bounds:

$$PPowerclass + DPIBE - MAX ( MAX ( MPRf , c , A - MPRf , c , ) + Δ MBP , n , P - MPRf , c ) - MAX \{ T ( MAX ( MPRf , c , A - MPRf , c , ) ) , T ( P - MPRf , c ) \} \leq PUMAX , f , c \leq EIRPmax$$

The corresponding measured total radiated power while the PTMAX,f,c may be calculated based on:

$$PTMAX , f , c \leq TRPmax$$

When considering UL polarization-based transmissions, the power density for a cross-polarization antenna system may be split in two equal parts, or it may go higher based on the WTRU Power Class capabilities. For example, a WTRU may have full EIRP power capability on a polarization (Hz and Vt) for a panel or a combination of panels serving at least a beam. The WTRU may be in a power sharing status between the simultaneous UL transmissions. In examples, the WTRU may have half power per polarization (Hz and Vt) for a panel or a combination of panels serving at least a beam. The WTRU may be in a so-called non-power sharing status.

Pcmax determination rules for polarization-based UL simultaneous transmissions may be included. For simultaneous UL transmissions, in a polarization-based mode of operation, the WTRU may determine a first Pcmax limit (e.g. PCMAX,f,c,Vt) related to a first UL grant and a first beam (described by a first UL TCI—as a spatial filter) and a second Pcmax limit (e.g. PCMAX,f,c,Hz) related to a second UL grant and a second beam (described by a second UL TCI—as a spatial filter).

If the WTRU is in a power sharing status, the current MPR and A-MPR may be required to be applied per polarization, and for a UL beam the equation for FR2 look like the following. On an EIRP side, PCMAX,f,c,Vt and PCMAX,f,c,Hz may individually respect the following inequality per polarization:

$$PPowerclass + {DP}_{IBE} - MAX ( MAX ( MPRf , c , A - MPRf , c , ) + Δ MBP , n , P - MPRf , c ) - MAX \{ T ( MAX ( MPRf , c , A - MPRf , c , ) ) , T ( P - MPRf , c ) \} \leq PUMAX , f , c \leq EIRPmax$$

The measured PUMAX,f,c,Hz and PUMAX,f,c,Vt may comply individually with the EIRP limit. The corresponding measured total radiated power P_{TMAX,f,c} that can be P_{TMAX,f,c,Hz} or P_{TMAX,f,c,Vt} and may be bounded by:

$${P}_{TMAX , f , c} \leq TRPmax$$

The inequalities may be respected by the determined Pcmax EIRP and Total Transmitted Power limits for a polarization. As simultaneous UL transmissions may exist, the overlapping polarization-based Pcmax limits as Pcmax-Hz−PCMAX,f,c,Hz and Pcmax-Vt=PCMAX,f,c,Vt due to the particularity of a UL beam configuration (e.g., in terms of AoD (Angle of Departure) being small) may scale down their Pcmax-Hz or Pcmax-Vt to comply with the EIRPma limit or TRPmax limit.

At least one of the following inequalities may cause a Pcmax-Hz and/or Pcmax-Vt scaling:

$$Pumax - H z + Pumax - Vt \leq EIRPmax$$

$$Pumax - H z + Pumax - Vt \leq TRPmax$$

The Pumax−Hz+Pumax−Vt may be the measured values of Pcmax-Hz or Pcmax-Vt. When at least one of the above inequalities are not respected, the WTRU may scale down one of both limits.

In examples, if Pcmax1+Pcmax2 (e.g., Pcmax-Hz+Pcmax-Vt) exceeds a threshold (e.g., the WTRU power class or the WTRU power class for EIRPmax, and/or TRPmax), the WTRU may scale one or both of Pcmax1 and Pcmax2, such that the sum does not exceed the threshold.

In examples, in non-polarized-based transmissions, the WTRU may compute Pcmax per beam (TCI based) and it may scale Pcmax for at least one beam or both to comply with the EIRPmax and/or TRPmax or both limits. The power sharing status may be revealed to the gNB through a PHR report.

In examples, based on the WTRU receiving two UL grants over mDCI (two DCIs), the WTRU may compute the power allocations for a PUSCH transmissions P1 and P2, respectively. P1 and P2 may respect their evaluated/determined limits Pcmax1 and Pcmax2 respectively. In examples, if computed P1>Pcmax1, transmission P1 is Pcmax1; otherwise, transmission P1=computed P1. In examples, if computed P2>Pcmax2, transmission P2 is Pcmax2; otherwise, transmission P2=computed P2.

After completing the eventual power adjustments of P1 and P2 respectively, the WTRU may transmit PUSCH channels on a first polarization and the second polarization, respectively. Examples may include Pcmax scaling. In examples, if both UL (e.g., PUSCH) transmissions include UCI or both UL (e.g., PUSCH) transmissions do not include UCI, Pcmax1 and Pcmax2 may be scaled equally. In examples, if one of the first and second UL (e.g., PUSCH) transmissions includes UCI and the other does not, the Pcmax (e.g., Pcmax1 or Pcmax2) corresponding to the UL transmission that does not include UCI may be scaled.

In examples, determining the maximum power per polarization type (e.g., and performing the subsequent related actions) may be conditioned on at least one of the following: the RB allocations of the first and second UL transmissions overlap in both time and frequency; the RB allocations of the first and second UL transmissions overlap in time; the same panel of the WTRU serves both the horizontal and vertical polarizations; and/or the WTRU indicates its power capability as power sharing (e.g., for the antenna ports or antenna port groups associated with one or both of the UL transmissions).

The Multi-Panel WTRU, operating into a multi-TRP in inter-cell or intra-cell configuration (with two TRPs) may maintain two power control loops. The WTRU may measure the RSRP and maintain pathloss estimations for two beams that have their own active TCI state that describes the QCL properties of the linked RS for downlink and uplink. When the polarization-based operation is configured and enabled by gNB, the power control, pathloss measurements, and WTRU power capabilities used at a certain moment in time may be known by a gNB scheduler for an optimized scheduling process in terms of power, frequency, and time allocation.

Power Headroom Report (PHR) may be reported per cell or beam. This report may include the Pcmax (Configured Maximum Power) evaluated for the UL grant that includes the PHR MAC CE, the P-MPR (if the MPE on FR2 report is configured), and the PHR. The PHR may be computed against the Pcmax and the allocated power for UL grant. The P-MPR may be the power management reduction that is applied based on the MPE (Maximum Permitted Exposure in FR2) or SAR limit (in FR1) being exceeded for a certain amount of time.

The PHR MAC CE with multiple entries may have the following format for a serving cell n entry, as depicted in Table 3:

TABLE 3
PHR MAC CE

| | | |
|---|---|---|
| P | V | PH (Type X, Serving Cell n) |

| | |
|---|---|
| MPE or R | P_{CMAX,f,c} m |

In Table 3, P may be a bit that is set to “1” if the P-MPR for MPE is configured and applied and is higher than PMR_00 (e.g., the lowest value specified). V may be a bit that is related to the type of PHR (real of virtual) for the serving cell “n”. If PMP-R for MPE is reported, then this 2 bit field may accommodate 4 standard values, or otherwise be reserved (e.g., set to zero). PH may be a 6 bits value for a 64 range of quantized quantities in dB. Pcmax may be a 6 bits value for a 64 range of quantized quantities in dBm.

PHR triggering may be provided. PHR triggering conditions specified may be related to the phr-Tx-PowerFactorChange dB, which may be a threshold configured by the gNB at the RRC level. A change in the pathloss measurements that last for a certain amount of time, exceeding the configured phr-ProhibitTimer, may trigger a PHR, since the pathloss may be directly reflected in the power allocation. If the MPE/SAR sensors detect human body proximity for at least a certain amount of time and the P-MPR is above a certain threshold, it may trigger a PHR as well. The activation/de-activation of a cell in carrier aggregation mode may trigger a PHR.

A PHR may be triggered upon WTRU configuration or reconfiguration of the multi-TRP. A MPUE may have (e.g., different) power capabilities on (e.g., different) panels and panel combinations that may be used based on serving (e.g., multiple) UL beams simultaneously. The power capabilities may lead to different combinations of panel groups and antenna ports supporting simultaneous UL transmissions. Two categories may be considered around power sharing or non-sharing status of an antenna group/panel(s) that may serve the beams UL transmissions: In a UL Power sharing state, serving UL beam antenna ports allocated power may reach a WTRU PowerClass level in EIRP terms, and based on two beams being transmitted simultaneously, the total transmitted power may be capped (e.g., as EIRP or as a Total Radiated Power). PowerClass may be achieved for a polarization. In an UL non-sharing state, serving UL beam antenna ports allocated power may not reach the PowerClass level in EIRP terms (e.g., for example two panels may go up to 20 dBm while the PowerClass is 23 dBm), and there may be no restrictions for the total transmitted power. This may be valid for a polarization.

Upon (e.g., based on) configuration of a WTRU with a multi-TRP by the gNB, a PHR may be triggered. The PHR report may include the Pcmax and PHR per beam and an indication of the power sharing or non-sharing status, according to the serving panel configuration the WTRU uses for UL beams transmissions. Upon a multi-TRP re-configuration, meaning a change in active TCI, a serving or non-serving TRP, the WTRU may trigger a PHR including the Pcmax, the PHR per beam, and the power sharing status according to the serving panels configuration used for UL transmissions.

Upon (e.g., based on) a multi-TRP WTRU configuration enabling the polarization-based operation, the WTRU may trigger a PHR. The PHR may include polarization specific parameters related to the UL polarization-based transmissions. In examples, for a beam, the PHR may including at least one or a combination of the following parameters: the Pcmax per polarization, the related polarization based PHR, an indication of the active polarization, and/or a TRP index. A PHR may be triggered upon a change in WTRU power capabilities or UL serving panels. During the polarization-based operation, the WTRU may change serving panels based on DL measurements or due to power requirements. The WTRU on a UL serving beam may determine that the power requirement is reduced or increased. This decision may be based on a pathloss estimation against a TRP or both TRPs in the configuration. A change in power requirement may translate into a change in WTRU power capabilities. Upon a change in power capabilities, the WTRU may get into a power sharing or non-sharing status. The change may trigger a PHR, and the PHR may include at least one or a combination of the following parameters for at least one or more UL beams: the Pcmax per polarization, the related polarization based PHR, an indication of the active polarization, and/or a TRP index.

PHR triggering may occur based on the difference between measured Hz_RSRP and Vt_RSRP exceeding a threshold. When the polarization-based operation is active, the particularities of the performed measurements on both polarization components (Hz-horizontal or Vt-vertical) of the configured RS may lead to triggering conditions. The WTRU may maintain measurements for the Hz and Vt components of the configured or associated pathloss RS based on the polarization-based operation being configured by a gNB and active.

As the WTRU is continuously measuring and monitoring the Hz and Vt polarizations based RSRP for a TRP (e.g., Hz_RSRP and Vt_RSRP), the movement of the WTRU may lead to measurement changes between Hz and Vt for example based on the WTRU rotating. The Hz_RSRP and Vt_RSRP measurements may be performed against an RS that may be an SSB, a CSI-RS or a pathloss RS, while the Hz and Vt based RSRP measurements may be based on the same or different Rses. This may imply that one of Hz or Vt polarization may become better than the other, and the used polarization may change. When the WTRU determines that the difference between a measured Hz_RSRP and a measured Vt_RSRP exceed a threshold (e.g., a received and/or configured threshold) for at least an amount of time that may be configured, the WTRU may trigger a PHR.

A PHR may be triggered upon a change in WTRU UL active polarization(s). The WTRU configured in a multi-TRP configuration with polarization-based operation to enable polarization-based measurements that use multiple panels for both TRPs. Additionally, the gNB may ask for UL transmissions on specific polarization types that may be indicated along with a DCI UL grant.

The WTRU may use the polarizations for its uplink transmissions in its serving panels by optimizing the UL power per polarization and/or mitigating self-interference, as the polarization-based transmissions may be quasi-orthogonal at the WTRU RF frontend. This may occur based on overlapping transmissions happening and the RB allocations for the UL grants overlapping in frequency domain. When the WTRU determines that an active UL polarization in the UL for a beam or both beams use a change, the WTRU may trigger a PHR that may include at least one or a combination of the following parameters for at least one or a UL beam: the Pcmax per polarization, the related polarization based PHR, an indication of the active polarization, and/or a TRP index.

A PHR may be triggered upon a change of Pcmax for an active polarization exceeding a threshold. When the WTRU is configured for polarization-based operation or determines that the transmissions of an UL grant is in polarization-based operation, the Pcmax may be estimated for the intended polarization type 1 or 2. The Pcmax value may be estimated in the context of a simultaneous transmission for a multi-TRP scenario where the mDCI STxMP is configured. The UL grants may have overlapping RB allocations in frequency and time domain. The AoD of the simultaneous transmitted beams may create examples where power reductions may be required. As the self-interference between UL beam transmissions may imply higher MPR in certain situations, for which the gNB scheduler may not have full knowledge on the WTRU side, based on the estimated Pcmax change exceeding a configured or determined threshold, for a certain amount of time, the WTRU may trigger a PHR that may include at least one or a combination of the following parameters for at least one or a UL beam: the Pcmax per polarization, the related polarization based PHR, an indication of the active polarization, and/or a TRP index.

A PHR may be triggered for a change of a serving beam or a TCI activation/de-activation. When the at least one TCI state or group of TCI states are re-configured or activated/de-activated, or a change of at least of a beam due to a beam failure, for example, that may involve, for example, a change in a QCL type E related to the polarization and quasi colocation (QCL) of the configured or determined reference RS, the WTRU may change the serving panels, or power properties of the serving panels may change. When the TCI state(s) change possibly affecting serving antenna port(s) configuration, the WTRU may trigger a PHR that may include at least one or a combination of the following parameters for at least one or a UL beam: the Pcmax per polarization, the related polarization based PHR, an indication of the active polarization, a TRP index.

A PHR may be reported. If the multi-TRP is an inter-cell scenario, where the PCI for the cells is different, the PHR per serving cell concept may be maintained in terms of the order of the entries in the MAC CE for a serving cell number stating from the Pcell (pTRP) and following with the Scells as secondary TRPs. For an mDCI STxMP scenario, the WTRU may use a dual entry PHR MAC CE due to the simultaneous nature of the transmissions of the UL grants that may be independent code words with different RB allocations and MCS. A UL beam may have its own PHR.

If the multi-TRP example is an intra-cell where the TRPs have the same PCI, a rule may be to have the first entry as the pTRP, followed by the secondary TRPs in order. The PHR report multi-TRP inter-cell scenario may be transmitted to the TRPs due to the importance of it for a scheduler involved in the UL grant scheduling. The PHR report for an intra-cell case may be sent just to the anchor or pTRP cell that holds the control of the configuration.

In an example, the PHR report may be restructured. The TRPs may be numbered using indexes, part of the PHR report, and the (e.g., specific) indications related to the polarization cases (e.g., sharing/non-sharing power status, specific polarization type 1 or 2, or a measurement mode 1 or 2) may be directly indicated or inferred from the configured report format. In an example, the PHR report may be carried out into an RRC message capable of accommodating the (e.g., whole) structure of an enhanced PHR for mDCI STxMP that would use an extra octet that may include the specificity of polarization cases (e.g., power sharing/non-power sharing status or vice versa, specific polarization type 1 or 2, or a measurement mode 1 or 2).

The PHR report may include at least one or a combination of the following: Pcmax for a UL beam on their specific polarization (Pcmax_Hz and Pcmax_Vt); the status of the sharing/non-sharing power of the current serving panels/antenna ports; the power headroom for an individual beam and polarization; an indication of the active polarization which may be Hz (horizontal) or Vt (vertical); and/or there may be a TRP indication (per TRP) to identify the TRP associated with the active polarization indication, or the order of entries of the active UL polarizations indications in the PHR may indicate the association with a specific TRP.

Systems, methods, and instrumentalities are configured for polarization interference measurement and reporting using polarized reference signals. A wireless transmit/receive unit (WTRU) may receive channel state information reference signal (CSI-RS) measurement configuration information. The CSI-RS measurement configuration information may indicate a first polarization index and a second polarization index. The first polarization index may be associated with a first polarization type, and the second polarization index may be associated with a second polarization type. The WTRU may receive a trigger to perform polarization-based CSI-RS measurement reporting. The trigger may indicate reporting information. The WTRU may determine a polarization-based CSI-RS measurement based on the received CSI-RS measurement configuration information and based on the first polarization type or the second polarization type. The WTRU may send an indication to a network entity. The indication may indicate at least the polarization-based CSI-RS measurement. The polarization-based CSI-RS measurement may be determined based on the first polarization type or the second polarization type based on the reporting information. The trigger may be received in downlink control information (DCI). The reporting information may indicate the first polarization index or the second polarization index. The polarization-based CSI-RS measurement may be based on the first polarization index based on the reporting information indicating the first polarization index. The polarization-based CSI-RS measurement may be based on the second polarization index based on the reporting information indicating the second polarization index.

The polarization-based CSI-RS measurement may include one or more of a first polarization-based measurement based on the first polarization type or a second polarization-based measurement based on the second polarization type. The indication may indicate one or more of: a polarization type associated with one or more of the first polarization-based measurement or the second polarization-based measurement or an indication of a selected polarization type. The selected polarization type may include the first polarization type or the second polarization type. The polarization-based CSI-RS measurement may be based on the first polarization type or the second polarization type based on an RS source polarization.

Systems, methods, and instrumentalities are configured for polarization interference measurement and reporting using a polarized CSI-RS. A wireless transmit/receive unit (WTRU) may comprise a processor that is configured to receive a control state information reference signal (CSI-RS) measurement configuration, which may indicate at least one or more polarization information. Upon receiving a trigger for performing a polarization-based CSI-RS measurement reporting, the WTRU may determine the polarization-based CSI-RS measurement using the received CSI-RS measurement configuration and a polarization type based on the reporting information. The WTRU may send the polarization-based CSI-RS measurement.

In this WTRU, the polarization information may include multiple polarization indexes, with each index configured with a reference signal (RS) source that is uni-polarized. Each of these polarization indexes may be associated with a first and a second polarization type, which are determined based on the polarization of the RS source. The first polarization type may be horizontal polarization, while the second polarization type may be vertical polarization.

When two of the multiple polarization indexes are identified, the associated polarization types for each index may be different. For example, a first index may be associated with the first polarization type, while a second index may be associated with the second polarization type. The trigger and/or the CSI-RS measurement configuration may include reporting information, such as a reporting mode or sub-mode, which is used to determine whether to use the first or the second polarization type for CSI-RS reception and/or measurement.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

What is claimed is:

1. A wireless transmit/receive unit (WTRU) comprising:
a processor configured to:
receive channel state information reference signal (CSI-RS) measurement configuration information, wherein the CSI-RS measurement configuration information indicates a first polarization index and a second polarization index, wherein the first polarization index is associated with a first polarization type and the second polarization index is associated with a second polarization type;
receive a trigger to perform polarization-based CSI-RS measurement reporting, wherein the trigger indicates reporting information;
determine a polarization-based CSI-RS measurement based on the received CSI-RS measurement configuration information and based on the first polarization type or the second polarization type; and
send an indication to a network entity, wherein the indication indicates at least the polarization-based CSI-RS measurement.

2. The WTRU of claim 1, wherein the polarization-based CSI-RS measurement is determined based on the first polarization type or the second polarization type based on the reporting information.

3. The WTRU of claim 1, wherein the trigger is received in downlink control information (DCI), and wherein the reporting information indicates the first polarization index or the second polarization index.

4. The WTRU of claim 3, wherein the polarization-based CSI-RS measurement is based on the first polarization index based on the reporting information indicating the first polarization index.

5. The WTRU of claim 3, wherein the polarization-based CSI-RS measurement is based on the second polarization index based on the reporting information indicating the second polarization index.

6. The WTRU of claim 1, wherein the polarization-based CSI-RS measurement comprises one or more of a first polarization-based measurement based on the first polarization type or a second polarization-based measurement based on the second polarization type, and wherein the indication further indicates one or more of: a polarization type associated with one or more of the first polarization-based measurement or the second polarization-based measurement or an indication of a selected polarization type, wherein the selected polarization type comprises the first polarization type or the second polarization type.

7. The WTRU of claim 1, wherein the polarization-based CSI-RS measurement is based on the first polarization type or the second polarization type based on an RS source polarization.

8. A method for a wireless transmit/receive unit (WTRU) comprising:
receiving channel state information reference signal (CSI-RS) measurement configuration information, wherein the CSI-RS measurement configuration information indicates a first polarization index and a second polarization index, wherein the first polarization index is associated with a first polarization type and the second polarization index is associated with a second polarization type;
receiving a trigger to perform polarization-based CSI-RS measurement reporting, wherein the trigger indicates reporting information;
determining a polarization-based CSI-RS measurement based on the received CSI-RS measurement configuration information and based on the first polarization type or the second polarization type; and
sending an indication to a network entity, wherein the indication indicates at least the polarization-based CSI-RS measurement.

9. The method of claim 8, wherein the polarization-based CSI-RS measurement is determined based on the first polarization type or the second polarization type based on the reporting information.

10. The method of claim 8, wherein the trigger is received in downlink control information (DCI), and wherein the reporting information indicates the first polarization index or the second polarization index.

11. The method of claim 10, wherein the polarization-based CSI-RS measurement is based on the first polarization index based on the reporting information indicating the first polarization index.

12. The method of claim 10, wherein the polarization-based CSI-RS measurement is based on the second polarization index based on the reporting information indicating the second polarization index.

13. The method of claim 8, wherein the polarization-based CSI-RS measurement comprises one or more of a first polarization-based measurement based on the first polarization type or a second polarization-based measurement based on the second polarization type, and wherein the indication further indicates one or more of: a polarization type associated with one or more of the first polarization-based measurement or the second polarization-based measurement or an indication of a selected polarization type, wherein the selected polarization type comprises the first polarization type or the second polarization type.

14. The method of claim 8, wherein the polarization-based CSI-RS measurement is based on the first polarization type or the second polarization type based on an RS source polarization.
